(19) United States
(12) Patent Application Publication
(10) Pub. No.: US 2010/0171614 A1
(43) Pub. Date: Jul. 8, 2010

(54) Antenna Impedance-Based Apparatus and Method for Detecting a Breach in the Integrity of a Container

(75) Inventors: Julio I. Concho, Farmington, CT (US); Jae-Hyuk Oh, Farmington, CT (US); Joseph Zacchio, Farmington, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: CHUBB INTERNATIONAL HOLDING LIMITED, SUNBURY-ON THAMES (GB)

(21) Appl. No.: 11/884,820

(22) PCT Filed: Feb. 22, 2005
(86) PCT No.: PCT/US05/05234

§ 371 Date: Jul. 9, 2009

(51) Int. Cl. G08B 13/00

(52) U.S. Cl. 340/550

(57) ABSTRACT

A security breach in the integrity of a container (10), such as a cargo container or a security vault, is detected using an apparatus (12) formed of a transmitter (18) and a processor (20). The transmitter (18) includes an antenna (26) that radiates electromagnetic waves from within the container (10). The processor (20) measures an impedance of the antenna (26) and produces an alarm if the impedance of the antenna (26) strays indicating a security breach in the integrity of the container (10).

### BACKGROUND OF THE INVENTION

The present invention relates generally to the field of security, and more particularly, to an apparatus and a method for detecting a breach in the integrity of a cargo container.

Due to increased criminal activities, such as people trafficking and the threat of container-borne terrorist attacks, the security of cargo containers has received increased attention. Until recently, security procedures for cargo containers have relied upon visual inspections and some limited automation, notably, electronic door locks and seals. Such security measures, however, are lacking. While electronic door locks and seals can raise an alarm if the seal is broken or if the door is opened or removed, they cannot detect the presence of stowaways who find a way into the container before the container is sealed closed, nor do they monitor the integrity of the container structure itself.

Very few commercially available products exist to detect breaches in the integrity of the container structure itself. One such system relies upon light sensors that respond to external light that may become visible when a hole is cut through a wall of the container or the container door is opened. However, these systems do not work if there is no external light, such as occurs at night or inside a dark warehouse or ship. These systems cannot detect the presence of stowaways. Moreover, the contents of the cargo container themselves may block any light from reaching the sensor.

Accordingly, there remains a need for new automated systems for monitoring the integrity of cargo containers.

### BRIEF SUMMARY OF THE INVENTION

The present invention is premised upon the fact that a typical cargo container is essentially a Faraday cage, in that, when sealed (i.e., when the doors are closed), the passage of electromagnetic waves through the walls of the container is substantially blocked. A security device in accord with the present invention makes use of this property by positioning a transmitter having an antenna inside the container to transmit electromagnetic waves. A processor of the security device then monitors an impedance of the antenna and produces an alarm if it detects a change in the impedance of the antenna. Because the container is essentially a Faraday cage, changes in the antenna impedance are indicative of a security breach such as the container door being opened, a hole being cut into the container walls, or the contents of the container shifting (such as when a stowaway moves about the container).

### BRIEF DESCRIPTION OF THE DRAWINGS

FIG. 1 is a schematic drawing of a container having a security device positioned therein for detecting a security breach of the container.

FIG. 2. is a block diagram of the security device of FIG. 1.

FIG. 3 is a graph comparing a reflection coefficient of an antenna positioned in a container having characteristics of a Faraday cage with and without a hole in a wall of the container.

FIG. 4 is a Smith chart for a reflection coefficient of an antenna positioned in a container having characteristics of a Faraday cage both with and without the presence of an intruder.

### DETAILED DESCRIPTION

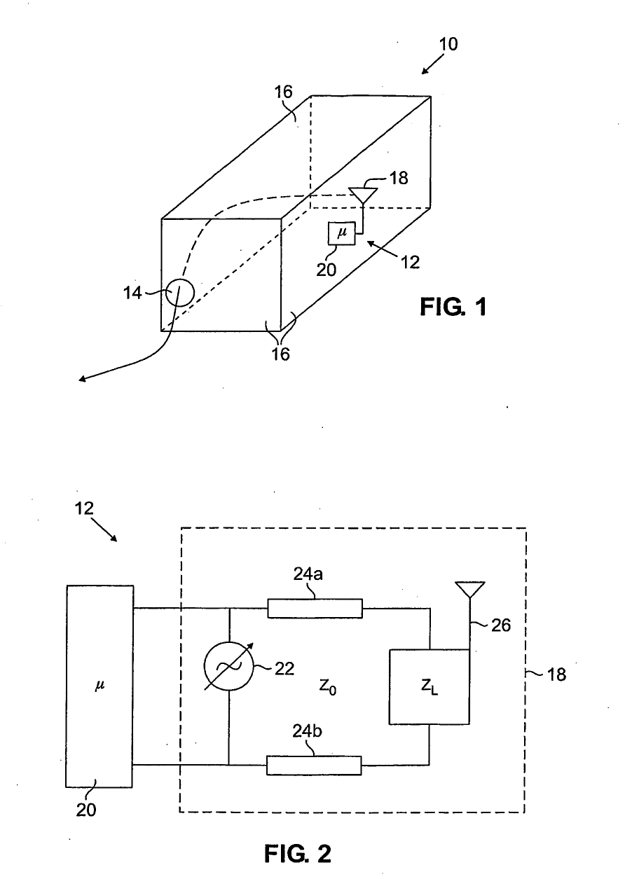

FIG. 1 is a schematic drawing of container 10 having security device 12 positioned therein for detecting security breach 14 of container 10. As shown in FIG. 1, security breach 14 is a hole in wall 16 of container 10. However, other detectable security breaches 14 may include without limitation the opening of a door of container 10 or the contents of container 10 shifting.

Container 10 is essentially a Faraday cage through which minimal or no electromagnetic radiation is allowed to transfer. As such, container 10 may be a cargo container, a bank vault, a motor vehicle, or another structure substantially immune to the passage of electromagnetic radiation. For instance, container 10 may also be a nonmetallic container coated with a metallic paint or a building formed of either plaster with metal mesh or rebar concrete. It is rare that container 10 would be a perfect Faraday cage. That is, container 10 is likely to have ventilation or other small holes cut into walls 16 and/or leaky seals around its door through which electromagnetic radiation can pass. Thus, it is expected that some electromagnetic radiation will traverse walls 16 of container 10.

FIG. 2 is a block diagram of security device 12 having transmitter 18 and processor 20. Transmitter 18 includes variable frequency signal generator 22, transmission lines 24a and 24b (jointly transmission lines 24), and antenna 26. Security device 12 is placed inside container 14 and, in many embodiments, is intended to be a stand-alone device. In these embodiments, security device 12 is preferably battery-powered. However, in some applications of the present invention, such as where container 10 remains in a single location easily accessible to line-power (such as where container 10 is a bank vault), security device 12 may be line-powered.

Variable-frequency signal generator 22 generates a signal that is conveyed by transmission lines 24 to antenna to radiate electromagnetic waves. In an exemplary embodiment, the signal is a radio or microwave frequency signal. Signal generator 22 is capable of producing a signal having a single frequency or a variable frequency. For instance, the frequency of the generated signal may be stepped through selected values or it may be swept over a band of frequencies. Alternatively, signal generator 22 may generate a multi-frequency signal.

Impedance Z_{L} of antenna 26 is a complex ratio between the voltage applied to antenna 26 (the transmitted signal) and the resulting current in antenna 26 (the received signal). Impedance Z_{L} of antenna 26 will vary depending upon whether it is placed inside container 10 or in free-space. This is due to the fact that, when antenna 26 is placed inside container 10, a large fraction of the power radiated by antenna 26 will be reflected back to antenna 26 by walls 16, while the remaining power is dissipated by Ohmic losses in walls 16. Conversely, if antenna 26 is placed in free-space, very little to none of the power radiated by antenna 26 will be reflected back to antenna 26. Thus, impedance Z_{L} of antenna 26 will be much larger when antenna 26 is placed in container 10 than when it is placed in free-space. Near the resonant frequencies of container 10, this difference can be of several orders of magnitude.

Likewise, when breach 14 in container 10 is present, a substantial fraction of the power radiated by antenna 26 will leak out of container 10 through breach 14. This loss of radiated power will render antenna 26 a more efficient radiator and will cause a change in impedance Z_{L} of antenna 26. The magnitude of this change in impedance Z_{L} will depend upon the frequency of the signal generated by signal generator 22, the size of breach 14, the size of container 10, and the nature of the contents in container 10. Changes in the value of impedance Z_{L} due to the presence of breach 14 are typically about a few percentage points.

The reflection coefficient ρ of antenna 26 varies as a function of impedance Z_{L} of antenna 26 and is computed as:

$$ρ = \frac{{Z}_{L} - {Z}_{0}}{{Z}_{L} + {Z}_{0}} \qquad ( Formula 1 )$$

where Z₀ is the impedance of transmission lines 24 and Z_{L} is the impedance of antenna 26. Impedance Z₀ of transmission lines 24 is a constant value that can be measured prior to installation of security device 12 in container 10. Reflection coefficient ρ of antenna 26 is affected by breach 14 more significantly than impedance Z_{L}, and thus is often a better predictor of breach 14.

To detect breach 14, processor 20 monitors impedance Z_{L} of antenna 26 and produces an alarm if it detects any changes. In implementing the present invention, it not important that container 10 be a perfect Faraday cage, but only that security device 12 be able to detect any new breaches of container 10. Thus, the fact that container 10 without breach 14 leaks some radiation is not significant if processor 20 can still identify a change in leakage, as detected by monitoring a change in impedance Z_{L} of antenna 26.

In detecting this change, it is important to determine baseline impedance Z_{LB} with which to compare monitored impedance Z_{L}. Because impedance Z_{L} of antenna 26 depends upon the size of container 10 and the nature of the contents in container 10, baseline impedance of antenna 16 is preferably determined sometime after container 10 is sealed, but anytime prior to the occurrence of breach 14.

Impedance Z_{L} of antenna 26 is also dependent upon the frequency of the signal generated by signal generator 22. Accordingly, a measured impedance Z_{L} of antenna 26 for a given frequency signal is preferably compared to a baseline impedance Z_{LB} of antenna 26 for the same frequency signal. In one embodiment, signal generator 22 will generate signals having varied frequencies because the size and shape of breach 14 that can be detected is dependent upon the frequency of the signal generated by signal generator 22. That is, a transmitted signal cannot pass through a hole smaller than its wavelength. Accordingly, the frequency of the transmitted signal defines the smallest detectable breach 14 in container 10. Thus, by varying the frequency of the signal produced by signal generator 22, security device 12 is better equipped to detect the presence of breach 14 regardless of the size and shape of breach 14. In another embodiment, security device 12 may operate with only a single frequency signal being generated by signal generator 22.

Processor 20 of security device 12 includes circuitry to measure impedance Z_{L} of antenna 26, perform the computations necessary to determine if impedance Z_{L} has changed due to breach 14, and produce an alarm upon such detection. In monitoring impedance Z_{L}, processor 20 may continuously monitor for breach 14. Alternatively, processor 20 may only periodically or intermittently check for breach 14. For instance, processor may control signal generator 22 to briefly transmit a signal to antenna 26 once a minute and then measure the resultant impedance Z_{L} of antenna 26. By only periodically or intermittently checking for breach 14, security device 12 conserves energy and prolongs the life of security device 12. This is especially important for application to shipping containers where security device 12 is battery operated and must survive long periods of transit.

Measured impedance Z_{L} is likely to vary slightly, even without breach 14, due to noise and minor shifts of the contents of container 10. To account for such variations, processor 20 may monitor for a deviation greater than a threshold deviation from measured baseline impedance Z_{LB}.

Processor 20 may be programmed in any of a variety of methods for detecting breach 14. According to one method, signal generator 22 generates a signal having its frequency swept through a band of frequencies to transmit to antenna 26. At each frequency i, processor 20:
Measures impedance Z_{Li}, of antenna 26;
Determines measured reflection coefficient ρᵢ using formula 1 above; and
Determines difference dᵢ equal to measured reflection coefficient ρᵢ minus baseline reflection coefficient ρ_{iB}.
   Once each difference dᵢ is computed, processor 20 determines a breach indicator value as the sum of the squared absolute values of differences dᵢ. and produces an alarm if this breach indicator value exceeds a threshold breach indicator value. As illustrated in this example, the breach indicator value is simply a function of measured impedances Z_{Li}, and numerous other possible functions exist. For instance, for each frequency i, processor 20 may:
Measure impedance Z_{Li}, of antenna 26; and
Determine difference dᵢ equal to measured impedance Z_{Li} minus baseline impedance Z_{LBi}.
   Processor 20 may then determine a breach indicator value as the sum of absolute values of differences dᵢ.

According to a second method, the frequency of the signal generated by signal generator 22 is stepped through frequencies i. For each frequency, processor 20 may determine if a difference between measured impedance Z_{Li} and a baseline impedance Z_{LB} exceeds a threshold deviation or it may evaluate a breach indicator value as a function of measured impedances Z_{Li} for all of the generated frequencies. Alternatively, processor 20 may evaluate a measured reflection coefficient ρᵢ, either individually at each frequency i, or together as a breach indicator value determined as a function of the measured reflection coefficient ρᵢ.

According to a third method, signal generator 22 generates a single frequency signal, and processor 20 compares measured impedance Z_{L} (or reflection coefficient ρ computed therefrom) to baseline impedance Z_{LB} (or baseline reflection coefficient ρ_{B}) determined at the same frequency. If a difference between the two values exceeds a threshold deviation, processor 20 generates an alarm.

Where the signal generated by signal generator 22 is a multi-frequency signal, processor 20 observes the signal reflected back to antenna 26, from which it can determine impedance Z_{L} (or reflection coefficient ρ) corresponding to each frequency of the multi-frequency signal. From this, processor 20 can detect a breach as described above.

In other embodiments of the present invention, multiple security devices 12 may be positioned within container 10. The use of multiple security devices 12 may be particularly beneficial where the contents of container 10 include metal objects which may block the propagation of electromagnetic waves throughout the entire interior of container 10. In this situation, a single security device 12 may not be able to detect breach 14 of container 10 if a metallic object resides between security device 12 and breach 14. The use of multiple security devices 12 helps overcomes this problem by ensuring that at least one of the multiple security devices 12 can detect breach 14.

The generation of alarms is well known in the field of security. In producing an alarm, processor 20 has numerous options. In a simple example, processor 20 may set a flag indicative of the occurrence of breach 14, which a separate device (not illustrated) connected thereto may process to alert the appropriate persons. For instance, a transmitting device may be mounted on an outside surface of container 10, and wired through walls 16 of container 10 for transmitting an alarm signal to the authorities. The alarm signal may be transmitted via any transmission protocol, including satellite, radio frequency, and hard-wired transmission. For instance, where container 10 is a cargo container in ocean-transit, satellite transmission of the alarm signal may be preferred. But, where container 10 is a bank vault, a hard-wired transmission may be most appropriate.

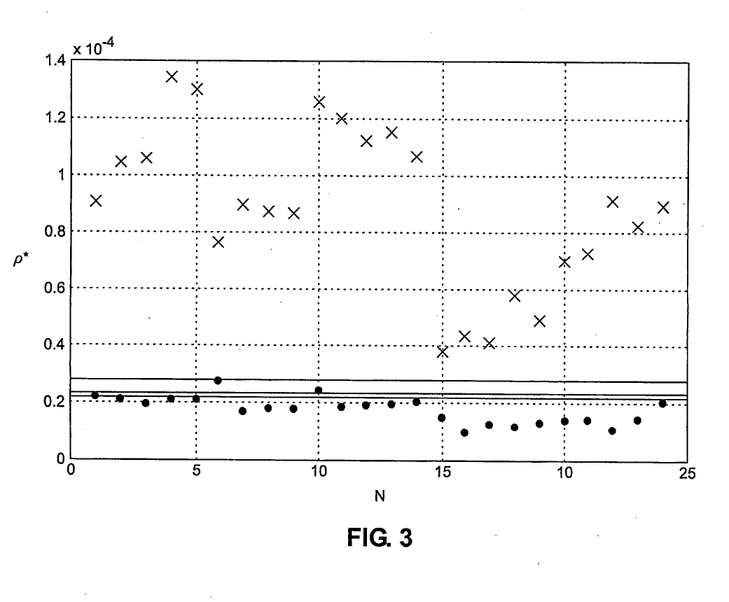

FIG. 3 is a graph comparing a reflection coefficient of an antenna positioned in a container having characteristics of a Faraday cage with and without a hole in a wall of the container for 25 different tests. For each test, a signal having its frequency swept through a broad band of frequencies was transmitted to an antenna to be radiated as electromagnetic waves in the container—both with and without the security breach. At each frequency, a reflection coefficient was computed from the measured impedance, and a difference between the computed reflection coefficient and a baseline reflection coefficient was determined. Then, for each test, breach indicator value ρ* was computed as a sum of the squared differences recorded at each frequency, again both with and without the security breach.

The results of this experiment are plotted in FIG. 3, with the breach indicator value ρ* being plotted on the vertical axis and the test number (“N”) (having no particular significance) on the horizontal axis. Breach indicator value ρ* determined without a breach is denoted by an “O” on the graph, while breach indicator value ρ* determined with the breach is denoted by an “X” on the graph. In each experiment, breach indicator value ρ* (representative of the impedance of the antenna over a band of frequencies) was greater when a hole was present than when the hole was not present.

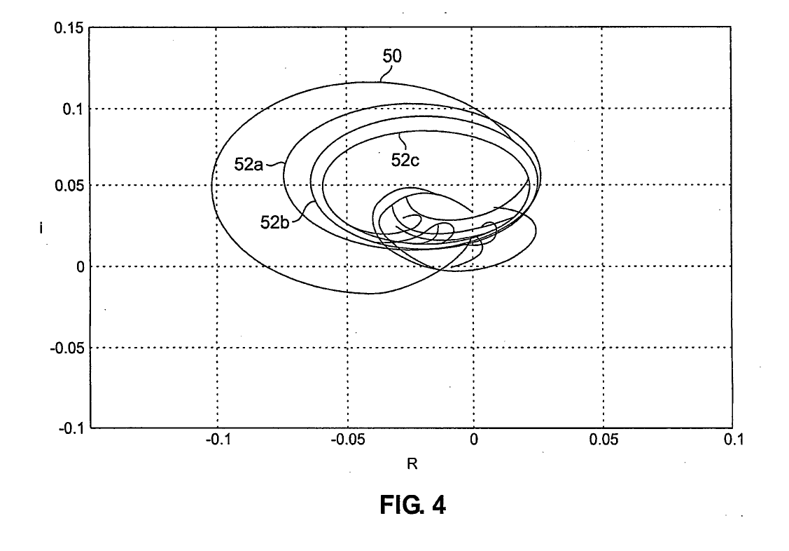

FIG. 4 is a Smith chart showing, in a complex plane, a reflection coefficient of an antenna positioned in a container having characteristics of a Faraday cage both with and without the presence of an intruder. The intruder may be an animate or inanimate change in the container contents.

Baseline reflection curve 50 graphs the reflection curve for the antenna when no intruder is present in the container, while reflection curves 52, 54, and 56 graph the reflection curves for the antenna when different intruders are present in the container. To generate each reflection curve, the contents of the container remained constant, while a signal having its frequency swept over a band of frequencies was transmitted to the antenna to be radiated as electromagnetic waves in the container. At each frequency, the reflection coefficient was recorded and plotted. FIG. 4 illustrates that the change in the reflection coefficient is more pronounced for the antenna at certain frequencies than at others. That is why it is advantageous to vary the frequency of transmitted signal. Moreover, by looking at the differences in impedances at a plurality of frequencies, the resultant change caused by a breach in the structural integrity of the container is less likely to be missed.

In sum, the present invention introduces a novel system and method for detecting a breach in the integrity of a container having characteristics of a Faraday cage, such as a cargo container or a bank vault. A signal is transmitted to an antenna for radiation in the container. By monitoring an impedance of the antenna for change, breaches in the integrity of the container can be detected. The system is robust to environmental and human threats since all elements in the system are positioned inside the container. The system is of low cost due to a simple apparatus and algorithm, which is based on off-the-shelf products. The system has a low operation and maintenance cost due to no mechanical elements and no optical/fragile elements. Finally, the performance of the system is independent of the contents of the container.

Although the present invention has been described with reference to preferred embodiments, workers skilled in the art will recognize that changes may be made in form and detail without departing from the spirit and scope of the invention.

1. An apparatus for detecting a breach in integrity of a container, the apparatus comprising:
a transmitter having an antenna that radiates electromagnetic waves from within the container; and
a processor that measures an impedance of the antenna and determines if the measured impedance of the antenna indicates a breach in the integrity of the container.

2. The apparatus of claim 1 wherein the transmitter further includes a signal generator that generates a signal for transmission to the antenna.

3. The apparatus of claim 2 wherein a frequency of the signal is swept over a band of frequencies.

4. The apparatus of claim 2 wherein the signal is a radio frequency signal.

5. The apparatus of claim 2 wherein the signal is a microwave frequency signal.

6. The apparatus of claim 1 wherein the processor indicates a breach when a difference between the measured impedance of the antenna and a baseline impedance of the antenna exceeds a threshold deviation.

7. The apparatus of claim 1 wherein the processor generates an alarm upon determining that the measured impedance of the antenna indicates a breach in the integrity of the container.

8. The apparatus of claim 1 wherein the container is a cargo container.

9. The apparatus of claim 1 wherein the container is a security vault.

10. A method for detecting a breach in integrity of a container, the method comprising:
radiating electromagnetic waves from an antenna positioned within the container;
monitoring an impedance of the antenna; and
detecting that a breach in the integrity of the container has occurred in response to a change of the impedance caused by a change in a structure or contents of the container.

11. The method of claim 10 continuously implemented.

12. The method of claim 10 periodically implemented.

13. The method of claim 10 wherein detecting that a breach in the integrity of the container has occurred comprises:
detecting whether a difference between the measured impedance of the antenna and a baseline impedance of the antenna exceeds a threshold deviation.

14. The method of claim 10 and further comprising:
producing an alarm upon detection of the occurrence of a breach in the integrity of the container.

15. A method for detecting a breach in integrity of a container, the method comprising:
generating a signal having its frequency swept over a band of frequencies;
for each frequency of the signal, transmitting that signal to an antenna for radiation of electromagnetic waves from within the container and measuring a resultant impedance of the antenna;
determining a breach indicator value based upon the measured impedances of the antenna; and
detecting whether the breach indicator value indicates a breach in the integrity of the container.

16. The method of claim 15 wherein the band of frequencies includes radio frequencies.

17. The method of claim 15 wherein the band of frequencies includes microwave frequencies.

18. The method of claim 15 wherein determining a breach indicator value comprises:
for each frequency of the signal, determining a difference between the measured impedance and a baseline impedance for that frequency; and
determining a breach indicator value as a sum of a square of the differences.

19. The method of claim 15 wherein determining a breach indicator value comprises:
for each frequency of the signal, determining a difference between a reflection coefficient based upon the measured impedance for that frequency and a baseline reflection coefficient for that frequency; and
determining a breach indicator value as a sum of a square of the differences.

20. The method of claim 15 wherein detecting whether the breach indicator value indicates a breach in the integrity of the container comprises:
detecting whether the breach indicator value exceeds a threshold breach indicator value.
